(19) United States
(12) Patent Application Publication
(10) Pub. No.: US 2005/0140319 A1
(43) Pub. Date: Jun. 30, 2005

(54) Automatic door opening/closing apparatus

(76) Inventor: Yoshikazu Takashima, Shiga (JP)

Correspondence Address: SNELL & WILMER LLP, 1920 MAIN STREET, SUITE 1200, IRVINE, CA, 92614-7230, US

(21) Appl. No.: 10/509,791

(22) PCT Filed: Feb. 4, 2003
(86) PCT No.: PCT/JP03/04241

(30) Foreign Application Priority Data
Mar. 4, 2002 (JP) 2002101097

(51) Int. Cl. H02P 1/00

(52) U.S. Cl. 318/286; 49/28

(57) ABSTRACT

In the event that while an outdoor surveillance sensor (10B) detects an object, an indoor surveillance sensor (10A) detects the object within a near detection area (11a) near to the door (1), it is determined that an intruder is trying to conduct an unauthorized entry into the building by inserting a sensor tripping item from an outdoor area into an indoor area through a gap in the door (1) and, hence, the door (1) is kept closed, to thereby increase the reliability of preventing the intruder from conducting the unauthorized entry. Also, when the outdoor surveillance sensor (10B) detects an object and the indoor surveillance sensor (10A) detects a different object within a distant detection area (11b) distant from the door (1), it is determined that a resident approaches the door (1), with the door (1) consequently opened and, accordingly, the resident can smoothly move from the indoor area to the outdoor area. In such case, since the indoor surveillance sensor (10A) detects no object within the near detection area (11a), it can be determined that a person in the outdoor area is not an intruder attempting to conduct an unauthorized entry into the building.

### FIELD OF THE INVENTION

The present invention generally relates to an automatic door control apparatus and, more particularly, to the automatic door control apparatus capable of providing a secure prevention of an unauthorized entry into a building.

### BACKGROUND ART

It is known that the conventional automatic door control apparatus has indoor and outdoor surveillance sensors installed at an entrance to a building such as a high-rise apartment house for monitoring the presence or absence of a human body in indoor and outdoor areas with respect to an automatic door, respectively, and also has a security input device installed outdoors. During the daytime, free entry from the outdoor area into the indoor area, and vice versa, is permitted by opening and closing an automatic door in response to detection of a human body by the indoor and outdoor surveillance sensors. However, during the nighttime, although leaving the indoor area into the outdoor area can be permitted by opening the automatic door in response to detection of a human body by the indoor surveillance sensor, the entry from the outdoor area into the indoor area is restricted for the purpose of prevention of the unauthorized intrusion into the building, requiring a particular person such as a resident in that building to insert a magnetic card or input an ID code into the security input device and then to open the automatic door to enter the indoor area.

However, it has been found that with the conventional apparatus, an intruder can open the automatic door by inserting a sensor tripping item or detection object from the outdoor area into the indoor area through a gap in the door to cause the indoor surveillance sensor to detect such sensor tripping item and, accordingly, the intrusion cannot be prevented satisfactorily.

In order to alleviate the problem discussed above, various attempts have hitherto been practiced, for example, (1) to close the gap in the door with an acrylic plate or the like to thereby physically prevent the sensor tripping item from being inserted and (2) to keep the automatic door closed even when the indoor surveillance sensor is detecting a person who is about to leave the building as long as the outdoor surveillance sensor is detecting an object or a person in the outdoor area. However, even those attempts have been found problematic, in that the attempt (1) requires a time-consuming job of mounting the plate to the door and the attempt (2) causes inconveniences to the person in the indoor area by keeping the automatic door closed, if persons and/or objects are present in the vicinity of the outdoor surveillance sensor, with the person in the indoor area consequently unable to go outdoors.

The Japanese Laid-open Patent Publication No. 11-311060, for example, discloses another attempt (3) in which in the event that an indoor surveillance sensor detects a sensor tripping item, which has been inserted from an outdoor area into an indoor area through a gap in a door moving deep into the indoor area, the automatic door will not be opened, but the automatic door can be opened only when an object approaches the automatic door from the indoor area. However, since this attempt (3) relies on the detection made solely by the indoor surveillance sensor for the prevention of the unauthorized entry, an erroneous operation tends to occur often, failing to achieve the reliability.

### DISCLOSURE OF THE INVENTION

In view of the foregoing, the present invention has been for its object to provide an automatic door control apparatus effective to eliminate the above discussed problems and inconveniences and to increase the reliability of preventing the unauthorized entry into a building.

In order to accomplish the foregoing object, an automatic door control apparatus according to the present invention includes indoor and outdoor surveillance sensors disposed in indoor and outdoor areas with respect to a door for detecting sensing waves emitted from an object, and an open/close control unit operable, in response to detection made by the indoor and outdoor surveillance sensors, to control selective opening and closure of the door. The indoor surveillance sensor includes a near detection area near to the door and a distant detection area distant from the door. The open/closure control unit includes a closure maintaining device for maintaining the door in a closed position when the indoor surveillance sensor detects an object within the near detection area while the outdoor surveillance sensor is detecting such object during the closure of the door, and an opening activating device for opening the door when the indoor surveillance sensor detects an object within the distant detection area even while the outdoor surveillance sensor is detecting a different object during the closure of the door.

According to the present invention, in the event that while the outdoor surveillance sensor detects an object, the indoor surveillance sensor detects such object within the near detection area, it is determined that an intruder is trying to conduct an unauthorized entry into the building by inserting a sensor tripping item from the outdoor area into the indoor area through a gap in the door and, hence, the door is kept closed, to thereby increase the reliability of preventing the intruder from conducting the unauthorized entry. Also, when the outdoor surveillance sensor detects an object and at the same time the indoor surveillance sensor detects a different object within the distant detection area in the indoor area, it is determined that a resident in the indoor area approaches the door, with the door consequently opened and, accordingly, the resident can smoothly move from the indoor area to the outdoor area. In such case, since the indoor surveillance sensor detects no object within the near detection area, it is determined that a person in the outdoor area is not an intruder attempting to conduct an unauthorized entry into the building.

In a preferred embodiment of the present invention, the outdoor surveillance sensor may have a near detection area near to the door and a distant detection area distant from the door. The closure maintaining device is operable to keep the door in the closed position when the outdoor surveillance sensor is detecting an object within the distant detection area thereof. Accordingly, the outdoor surveillance sensor can detect an intruder who is trying to conduct the unauthorized entry into the building by inserting the sensor tripping item from the outdoor area into the indoor area through the gap in the door, ensuring the high reliability of preventing the unauthorized entry.

In another preferred embodiment of the present invention, each of the indoor and outdoor surveillance sensors may be of a reflection type and the sensing waves may be those reflected from an object.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1(A) is a block diagram showing an automatic door control apparatus according to a preferred embodiment of the present invention;

FIG. 1(B) is a partial side view as viewed in a direction of sliding movement of a door of the automatic door control apparatus;

FIG. 2(A) is a side view of an area surveillance sensor assembly as viewed in the direction of sliding movement of the door of the automatic door control apparatus;

FIG. 2(B) is a bottom plan view of the area surveillance sensor assembly shown in FIG. 2(A);

FIG. 2(C) is a front elevational view of the area surveillance sensor assembly shown in FIG. 2(A), as viewed in a direction of movement of a person;

FIG. 3 is a side view of detection areas covered by the area surveillance sensor assembly, shown together with a plan view of such detection areas; and

FIG. 4 is a flowchart showing the sequence of operation of the automatic door control apparatus shown in FIGS. 1(A) and (B).

### BEST MODE FOR CARRYING OUT THE INVENTION

Hereinafter, the present invention will be described in detail in connection with a preferred embodiment thereof with reference to the accompanying drawings.

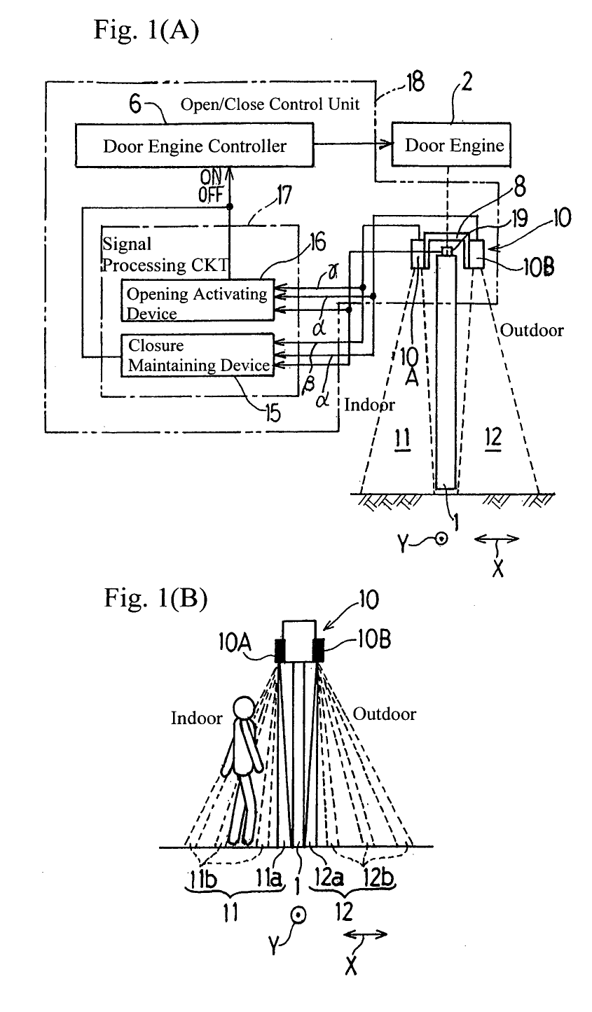

FIG. 1(A) illustrates a schematic block diagram showing an automatic door control apparatus according to the preferred embodiment of the present invention. The automatic door control apparatus is of a type capable of selectively opening and closing a door, for example, a sliding door 1 and includes an open/close control unit 18 for controlling a door engine 2 such as an 1 5 electrically operated drive motor which drives the sliding door 1 to selectively open and close such sliding door 1. The open/close control unit 18 includes a door engine controller 6, an area surveillance sensor assembly 10 made up of an indoor surveillance sensor 10A, installed in an indoor area with respect to the sliding door 1 for detecting sensing waves emanating from an object, and an outdoor surveillance sensor 10B installed in an outdoor area with respect to the sliding door 1 for detecting sensing waves emanating from an object, and a signal processing circuit 17.

The signal processing circuit 17 includes a closure maintaining device 15 and an opening activating device 16 and feeds either one of a Door Open 25 signal (an ON signal) and a Door Close signal (an OFF signal) to the door engine controller 6. The door engine 2 and the open/close control unit 18 are mounted within a hollow of a transom 8 for supporting an upper end portion of the door 1 or within the door 1. The door 1 has an open/close detecting sensor 19 such as a microswitch mounted on the upper portion of the door 1 for detecting the opening or closure of the door 1. The area surveillance sensor assembly 10 is in the form of, for example, an AIR system capable of projecting near infrared rays of light as the sensing waves and then receiving a portion of the near infrared rays of light reflected from an object to thereby detect the presence of such object.

The indoor surveillance sensor 10A and the outdoor surveillance sensor 10B are secured to outer side faces of the transom 8 so as to define and cover an indoor detection area 11 and an outdoor detection area 12 inside and outside a building with respect to the door 1, respectively. Each of the detection areas 11 and 12 is made up of a near detection area 11a or 12a near to the door 1 and extending generally vertically between the corresponding surveillance sensor 10A or 10B and the building floor as shown by the solid line in FIG. 1(B), and a plurality of generally juxtaposed distant detection areas 11b or 12b defined outside the near detection area 11a or 12b, that is, on one side of the near detection area 11a or 12b remote from the door 1 and extending diagonally between the corresponding surveillance sensor 10A or 10B and the building floor as shown by the broken lines in FIG. 1(B). In the embodiment as shown, one near detection area 11a or 12b and three distant detection areas 11b or 12b are defined on each side of the door 1, and each detection area 11 or 12 is so designed as to cover a region extending over the entire height of the door 1.

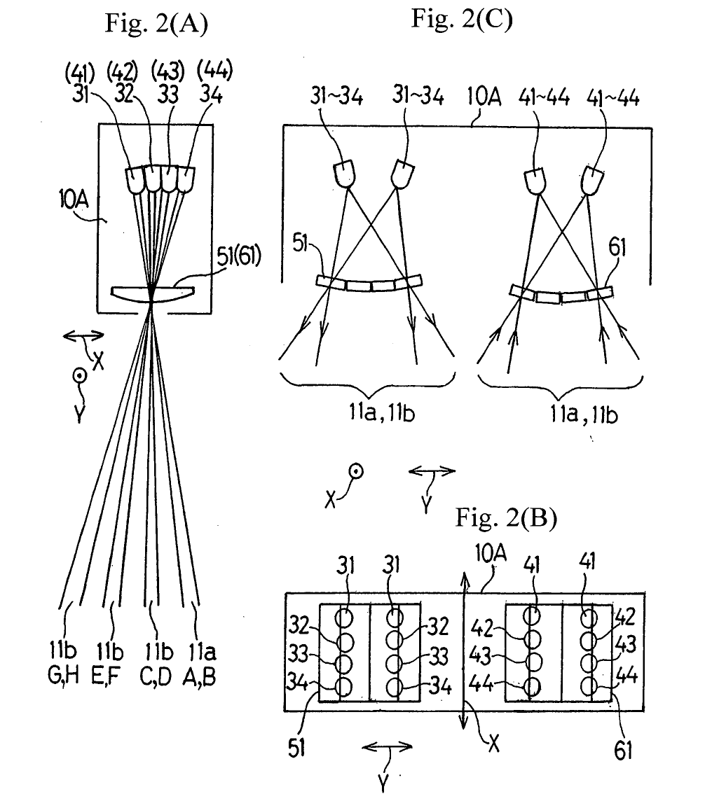

The indoor surveillance sensor 10A and the outdoor surveillance sensor 10B are of a substantially identical structure and, therefore, reference will be made to only the indoor surveillance sensor 10A in describing the details thereof for the sake of brevity. Referring to FIG. 2(A) showing a schematic side view of the indoor surveillance sensor 10A, the indoor surveillance sensor 10A is of the AIR system and includes, as arranged in the specific order when viewed in a direction Y of sliding movement of the door 1, a pair of first light projecting elements 31 for defining and covering the near detection area 11a and a pair of first light receiving elements 41 cooperable with the first light projecting elements 31; a plurality of, for example, three, pairs of second to fourth light projecting elements 32, 33 and 34 for defining and covering the second to fourth distant detection areas 11b and three pairs of second to fourth light receiving elements 42, 43 and 44 cooperable respectively with the second to fourth light projecting elements 32 to 34; a common light projecting lens 51 for projecting sensing waves in a predetermined pattern emitted from the light projecting elements 31 to 34, and a common light receiving lens 61 for forming the respective detection areas for the light receiving elements 41 to 44.

As shown in FIG. 2(B) in a bottom plan view, the pairs of the light projecting elements 31 to 34 are arrayed in two rows while the pairs of the light projecting elements 31 to 34 are juxtaposed relative to each other in a direction perpendicular to a direction X of movement of a human body, and similarly, the pairs of the light receiving elements 41 to 44 are arrayed in two rows while the pairs of the light receiving elements 41 to 44 are juxtaposed relative to each other in a direction perpendicular to the direction X of movement of a human body. On the other hand, as shown in FIG. 2(C) in a front elevational view, each of the light projecting lens 51 and the light receiving lens 61 is divided into four lens segments in a direction circumferentially thereof and, accordingly, each pair of the light receiving elements and the corresponding pair of the light projecting elements define eight detection sub-areas together.

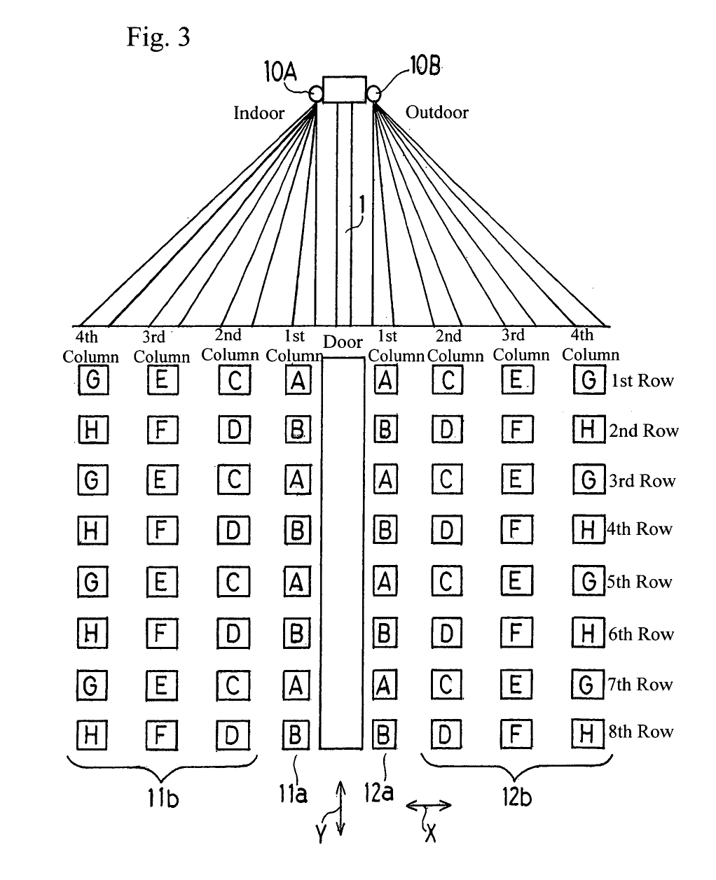

Thus, as shown in a plan view in a lower portion of FIG. 3, the detection areas 11 and 12 covered by the indoor and outdoor surveillance sensors 10A and 10B, respectively, each include eight sub-areas that are deployed in the direction Y and four sub-areas that are deployed in the direction X, representing a matrix of four columns and eight rows. In FIG. 3, legends “A” and “B” represent respective detection sub-areas of coverage formed on the floor by the light projecting elements 31 and 31; legends “C” and “D” represent respective detection sub-areas of coverage formed on the floor by the light projecting elements 32 and 32; legends “E” and “F” represent respective detection sub-areas of coverage formed on the floor by the light projecting elements 33 and 33; and legends “G” and “H” represent respective detection sub-areas of coverage formed on the floor by the light projecting elements 34 and 34.

It is to be noted that although, in the illustrated embodiment, the near detection areas 11a and 12a covered respectively by the indoor surveillance sensor 10A and the outdoor surveillance sensor 10B are assigned as the first column, and the distant detection areas 11b and 12b covered respectively by the indoor surveillance sensor 10A and the outdoor surveillance sensor 10B are assigned as the second to fourth columns, the near detection areas 11a and 12a and the distant detection areas 11b and 12b may be assigned as the first and second columns and the third and fourth columns, respectively, or the first to third columns and the fourth column, respectively. Also, the near detection areas 12a for the outdoor surveillance sensor 10B may be made up of the first to fourth columns, with no distant detection areas 12b employed at all.

The closure maintaining device 15 shown in FIG. 1(A) is operable to continue outputting the Door Close signal (the OFF signal) to the door engine controller 6 in response to receipt of a detection signal α, which is, during the closure of the door detected by the open/close detecting sensor 19, outputted from the outdoor surveillance sensor 10B when the outdoor surveillance sensor 10B detects the presence of an object within the near detection area 12a, and also in response to receipt of a detection signal β from the indoor surveillance sensor 10A when the indoor surveillance sensor 10A detects the presence of such object within the near detection area 11a. In response to the Door Close signal (the OFF signal) fed from the closure maintaining device 15, the door engine controller 6 causes the door engine 2 to maintain the door 1 in a closed position. Where no distant detection area 12b for the outdoor surveillance sensor 10B is employed, a detection signal generated when an object present somewhere in the entirety of the detection area 12 is detected can be used as the detection signal α. In the event that the Door Close signal (the OFF signal) is not generated, the Door Open signal (the ON signal) is issued to keep the door 1 open.

The opening activating device 16 is operable to output the Door Open signal (the ON signal) to the door engine controller 6 in response to receipt of the detection signal α, which is, during the closure of the door detected by the open/close detecting sensor 19, outputted from the outdoor surveillance sensor 10B when the outdoor surveillance sensor 10B detects the presence of an object within the near detection area 12a, and also in response to receipt of a detection signal γ from the indoor surveillance sensor 10A when the indoor surveillance sensor 10A detects the presence of an object, for example, a resident about to leave the building, within the distant detection area 11b. In response to the Door Open signal (the ON signal) fed from the opening activating device 16, the door engine controller 6 causes the door engine 2 to open the door 1. Where the Door Close sign (the OFF signal) is generated during the opening of the door 1, the operation to close the door 1 is performed.

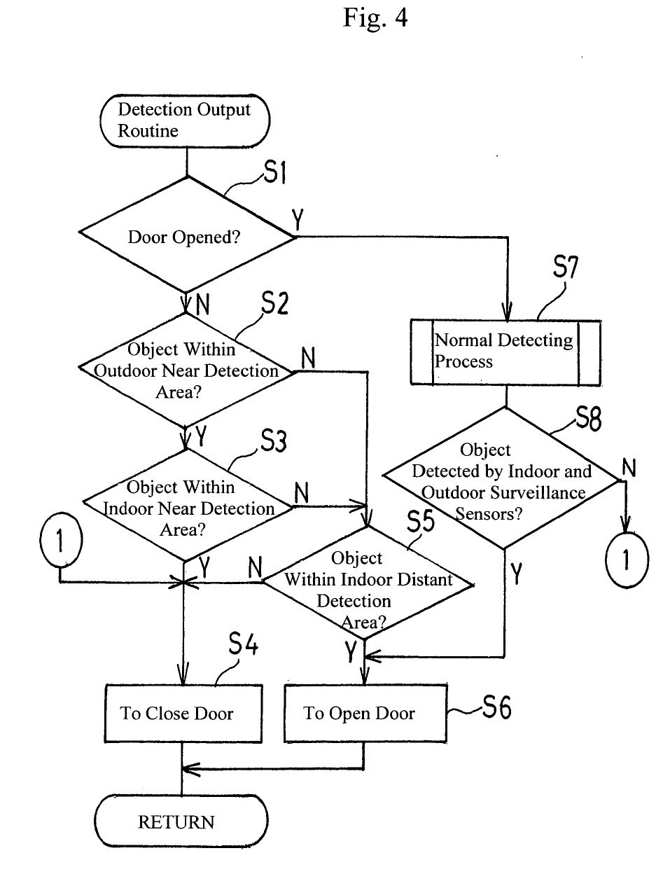

Hereinafter, the operation of the automatic door control apparatus of the present invention will be described in details with reference to the flowchart shown in FIG. 4.

At the outset, in reference to the detection signal fed from the open/close detecting sensor 19, a decision is made at step S1 to determine whether the door 1 is in an opened condition or not. If the door 1 is found to be closed, a decision is made at step S2 to determine if an object is detected within the first column of the distant detection area 12a covered by the outdoor surveillance sensor 10B. In the event that the object is detected within the first column of the distant detection area 12a, another decision is made at step S3 to determine if the object is detected also within the first row of the near detection area 11a of the indoor surveillance sensor 10A. If the object is detected within the near detection area 11a, the closure maintaining device 15 causes the door 1 to be kept closed at step S4.

Thus, when the object is detected within the near detection area 12a of the outdoor surveillance sensor 10B and is also detected within the near detection area 11a of the indoor surveillance sensor 10A, it is determined that an intruder is trying to insert a sensor tripping item into the indoor area through a gap in the door in an attempt to conduct an unauthorized entry into the indoor area and, hence, the door 1 is kept closed, thereby to increase the reliability of preventing the intruder from conducting an unauthorized entry. It is to be noted that, where a magnetic card or an ID code is inserted into or inputted to a security input device, such input signal is preferentially dealt with to open the door 1.

In the event that at step S2 the object is not detected within the near detection area 12a of the outdoor surveillance sensor 10B, or in the event that at step S3 the object is detected within the near detection area 12a of the outdoor sensor 10B, but not detected within the near detection area 11a of the indoor surveillance sensor 10A, a decision is made at step S5 to determine if an object is detected within the second to fourth columns of the distant detection areas 11b of the indoor surveillance sensor 10A. Where the object is detected within the distant detection area 11b of the indoor surveillance sensor 10A, the opening activating device 16 causes the door 1 to open at step S6. On the other hand, where the object is not detected within the near detection area 12a of the outdoor surveillance sensor 10B, it is determined that no intruder is found in the vicinity of the outdoor area and, hence, that there is no attempt to conduct an unauthorized entry.

Also, where an object is detected within the near detection area 12a of the outdoor surveillance sensor 10B, but not detected within the near detection area 11a of the indoor surveillance sensor 10A, it is determined that the object or person in the vicinity of the outdoor area is not attempting an unauthorized entry. At the same time, detection of an object within the distant detection area 11b of the indoor surveillance sensor 10A can be determined indicating that the resident within the indoor area approaches the door 1 to go outside. Accordingly, since the opening activating device 16 operates to open the door 1, the resident can smoothly go out of the building even though persons and/or objects are found in the vicinity of the outdoor area of the building. In the event that no object is detected within the distant detection area 11b of the indoor surveillance sensor 10A at step S5, it is determined that there is no resident moving from the indoor area to the outdoor area and, therefore, the door is kept in the closed position at step S4.

Also, in the event that at step S1 the door 1 is determined as opened, the normal detecting process is performed at step S7, followed by step S8 to determine if the area surveillance sensor assembly 10 is detecting a person entering or leaving the building. In the event that the area surveillance sensor assembly 10 is detecting such person, the door 1 is kept opened at step S6. On the other hand, if the area surveillance sensor assembly 10 is detecting no such person, the door 1 is closed at step S4.

It is to be noted that, in the foregoing embodiment of the present invention, in place of the determination at step S3 of whether or not an object is detected within the first column of the near detection area 11a of the indoor surveillance sensor 10A, determination may be made that an object is detected within the near detection area 11a in the event that, with the first and second columns of the indoor detection area 11 taken as the near detection areas 11a of the indoor sensor 10A, the object is detected sequentially from the first column to the second column (in the event that the object is inserted into the indoor area through the gap in the door 1), or the object is detected sequentially from the second column to the first column (in the event that the object once inserted is drawn from the indoor area to the outdoor area).

It is also to be noted that, in the foregoing embodiment of the present invention, in place of the determination at step S5 of whether or not an object is detected within the second to fourth columns of the distant detection areas 11b of the indoor surveillance sensor 10A, determination may be made that an object is detected within the distant detection areas 11b in the event that the object is detected sequentially from the fourth column to the third column and then to the second column. Furthermore, with the third and fourth columns taken as the distant detection areas 11b of the indoor surveillance sensor 10A, determination may be made that an object is detected within the distant detection areas 11b when the object is detected sequentially from the fourth column to the third column.

In describing the foregoing embodiment, the open/close detecting sensor 19 is employed for detecting the opening or closure of the door 1. However, the use of the open/close detecting sensor 19 may not be always essential in the present invention and may be dispensed with, in which case the detection area covered by each of the indoor and outdoor surveillance sensors 10A and 10B has to be so extended over the door 1 that the indoor and outdoor surveillance sensors 10A and 10B can detect the selective opening and closure of the door 1, or the door engine 2 itself can detect the opening and closure of the door 1 in reference to a door position signal represented by the number of revolutions of the motor.

Again, in describing the foregoing embodiment, the area surveillance sensor assembly 10 has been described as the AIR system, but it may be a PIR (passive infrared rays) system in which far infrared rays of light emanating from an object are detected. Also, an ultrasonic-wave type active sensor including transmitting and receiving elements for transmitting and receiving ultrasonic waves as sensing waves or a radio-wave type active sensor including transmitting and receiving elements for transmitting and receiving radio waves as sensing waves may be employed in place of the AIR system.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

1. An automatic door control apparatus which comprises:
indoor and outdoor surveillance sensors disposed in indoor and outdoor areas with respect to a door for detecting sensing waves emitted from an object, the indoor surveillance sensor including a near detection area near to the door and a distant detection area distant from the door;
an open/close control unit operable, in response to detection made by the indoor and outdoor surveillance sensors, to control selective opening and closure of the door, said open/closure control unit comprising;
a closure maintaining device for maintaining the door in a closed position when the indoor surveillance sensor detects an object within the near detection area while the outdoor surveillance sensor is detecting such object during the closure of the door; and
an opening activating device for opening the door when the indoor surveillance sensor detects an object within the distant detection area even while the outdoor surveillance sensor is detecting a different object during the closure of the door.

2. The automatic door control apparatus as claimed in claim 1, wherein the outdoor surveillance sensor has a near detection area near to the door and a distant detection area distant from the door and wherein the closure maintaining device is operable to keep the door in the closed position when the outdoor surveillance sensor is detecting an object within the near detection area thereof.

3. The automatic door control apparatus as claimed in claim 1, wherein each of the indoor and outdoor surveillance sensors is of a reflection type and wherein the sensing waves are those reflected from an object.

4. A system for automatically positioning a door in one of an open and closed state, comprising:
a door engine unit for providing movement to a door;
a first sensor unit mounted to monitor an interior first side of the door, including a near detection area to the door and a distant detection area away from the door, the first sensor unit enabled to provide a near detection signal and a distant detection signal; and
a second sensor unit mounted to monitor an exterior second side of the door, the second sensor unit enabled to provide a detection signal;
a signal processing unit for receiving signals from the first sensor unit and the second sensor unit, for processing the signals and providing corresponding signals to the door engine unit, the signal processing unit providing a priority open signal to the door engine unit when receiving a distant detection signal from the first sensor unit and providing a close signal when the first sensor unit provides a near detection signal and the second sensor unit provides a detection signal.

5. The system of claim 4 further including means for providing an override signal to open the door.

6. The system of claim 4 wherein the exterior second sensor unit monitors a near detection area to the door and a distant detection area away from the door.

7. The system of claim 6 wherein each of the detection areas is divided into an array of individual spaced sub-areas.

8. The system of claim 6 wherein the signal processing unit provides a close signal to the door engine unit when the exterior second sensor unit provides a near detection signal and the first sensor unit provides a near detection signal.

9. A system for automatically positioning a door in one of an open and closed state, comprising:
a door engine unit for providing movement to a door;
a first sensor unit mounted to monitor an interior first side of the door, including a near detection area to the door and a distant detection area away from the door, the first sensor unit enabled to provide a near detection signal and a distant detection signal, wherein each of the detection areas is divided into a two-dimensional array of individual spaced sub-areas;
a second sensor unit mounted to monitor an exterior second side of the door, the second sensor unit enabled to provide a near detection signal and a distant detection signal, wherein each of the detection areas is divided into a two-dimensional array of individual spaced sub-areas; and
a signal processing unit for receiving signals from the first sensor unit and the second sensor unit, for processing the signals and providing corresponding signals to the door engine unit, the signal processing unit providing a priority open signal to the door engine unit when receiving a distant detection signal from the first sensor unit and providing a close signal when the first sensor unit provides a near detection signal and the second sensor unit provides a near detection signal.
